(19) United States
(12) Patent Application Publication
(10) Pub. No.: US 2026/0104986 A1
(43) Pub. Date: Apr. 16, 2026

(54) FEATURE TOGGLE METRICS IN CONTINUOUS INTEGRATION AND CONTINUOUS DEPLOYMENT ENVIRONMENT

(71) Applicant: SAP SE, Walldorf (DE)

(72) Inventors: Stefan BUTSCHER, Sandhausen (DE); Christian LEHMANN, Malsch (DE)

(21) Appl. No.: 18/916,854

(22) Filed: Oct. 16, 2024

(51) Int. Cl. G06F 11/36

(52) U.S. Cl. CPC G06F 11/3676; G06F 11/3688

(57) ABSTRACT

A CI/CD environment may include a code data store that contains software code. A test execution infrastructure (e.g., associated with a developer using an IDE or CI/CD pipeline quality assurance) may trigger a test execution of the software code causing a coverage analyzer framework to automatically analyze the software code and determine which branches within the software code are relevant to feature toggles and their identifiers. The framework can then measure a number of branches relevant to feature toggle identifiers that have been executed as a result of the test execution. An indication of the number of branches relevant to feature toggles that were executed as a result of the test execution may be stored into a test result data store. The test result data store may further contain an overall branch coverage metric, a statement coverage metric, a procedure coverage metric, etc.

### BACKGROUND

Continuous Integration and Continuous Delivery or Deployment (“CI/CD”) streamlines and accelerates the software development lifecycle. In particular, continuous integration automatically and frequently integrates code changes into a shared source code repository. Continuous delivery refers to the integration, testing, and/or delivery of code changes. For example, an enterprise may develop applications, such as business applications associated with management, programming, tracking, etc. and implement automated code testing as part of the development process. The enterprise may want to ensure that the automated testing actually executes all (or substantially all) of the software code to detect bugs or failures. To help this determination, a test coverage analyzer may determine metrics such as statement and branch coverages. FIG. 1 is an illustration of software code 100 including code A through D. Initially, code A is executed until a “branch” is reached. After the branch, either code B or code D is executed. “Statement coverage” indicates how thoroughly a test executes each software code 100 statement. “Branch coverage” indicates how thoroughly a test executes each software code 100 branch (e.g., from code A to code B, from code A to code D, etc.). Note that a test might achieve 100% statement coverage but fail to achieve 100% branch coverage. For example, a test could execute all of the statements in the software code 100 without actually testing the branch from code D to code C (e.g., in case there is an “else” statement).

Feature toggles, also known as feature flags, are a powerful technique for software CI/CD (especially in cloud environments) because they decouple feature deployment and activation of the feature. A feature can be included in an application (e.g., a new dropdown menu selection) but remain “inactive” until it is “turned on” by the developer via a flag. This benefit comes at the cost, however, of rapidly growing complexity. For example, if a program has 10 feature toggles, there are already 1024 possible toggle combinations. Without strict control of feature toggles (and a disciplined removal of toggles after rollout), there can be a substantial risk of software bugs and failures caused by an unmanageable code base.

It would therefore be desirable to provide coverage analysis of software code branches that are associated with feature toggles in a secure, automatic, and efficient manner.

### SUMMARY

According to some embodiments, methods and systems associated with a Continuous Integration and Continuous Deployment (“CI/CD”) environment may include a code data store that contains software code. A test execution infrastructure (e.g., associated with a developer using an Integrated Development Environment (“IDE”) or CI/CD pipeline quality assurance) may trigger a test execution of the software code causing a coverage analyzer framework to automatically analyze the software code and determine which branches within the software code are relevant to feature toggles and their identifiers. The framework can then measure a number of branches relevant to feature toggle identifiers that have been executed as a result of the test execution. An indication of the number of branches relevant to feature toggles that were executed as a result of the test execution may be stored as a toggle metric into a test result data store. According to some embodiments, the test result data store further contains overall common metrics, such as branch coverage metric, a statement coverage metric, a procedure coverage metric, etc.

Some embodiments comprise: means for accessing, by a computer processor of a coverage analyzer framework, software code associated with the CI/CD environment from a code data store; means for triggering, by a test execution infrastructure, a test execution of the software code; means for automatically analyzing the software code to determine which branches within the software code are relevant to feature toggles and their identifiers; means for measuring a number of branches relevant to feature toggle identifiers that have been executed as a result of the test execution; and means for outputting an indication of the number of branches relevant to feature toggles that were executed as a result of the test execution as a toggle metric to a test result data store.

Some technical advantages of some embodiments disclosed herein are improved systems and methods to provide coverage analysis of software code branches associated with feature toggles in a secure, automatic, and efficient manner.

### BRIEF DESCRIPTION OF THE DRAWINGS

FIG. 1 illustrates statement and branch test coverage.

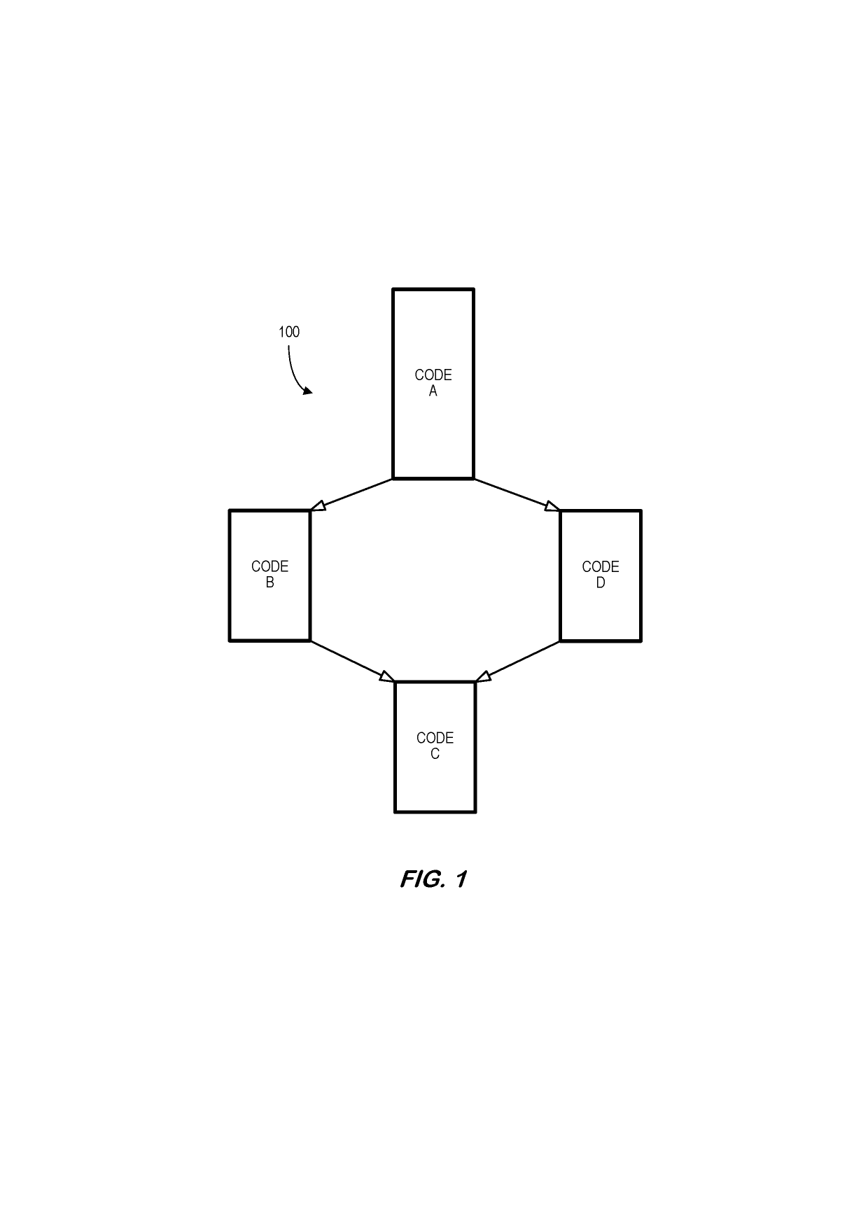

FIG. 2 is a high-level software test system architecture associated with a CI/CD environment in accordance with some embodiments.

FIG. 3 is a software test method according to some embodiments.

FIG. 4 is software code with feature toggles in accordance with some embodiments.

FIG. 5 is an Integrated Development Environment (“IDE”) coverage analysis according to some embodiments.

FIG. 6 is an IDE method in accordance with some embodiments.

FIG. 7 is an IDE test results display according to some embodiments.

FIG. 8 is a CI/CD monitoring pipeline analysis in accordance with some embodiments.

FIG. 9 is a CI/CD monitoring pipeline method according to some embodiments.

FIG. 10 is a CI/CD monitoring pipeline test results display in accordance with some embodiments.

FIG. 11 is an apparatus or platform according to some embodiments.

FIG. 12 is a portion of a test result data store in accordance with some embodiments.

FIG. 13 illustrates a tablet computer according to some embodiments.

FIG. 14 is an operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Having a detailed understanding of the feature toggle state and usage of the software is important to provide rigid control of software code. Moreover, CI/CD software development requires automatic tests to ensure quality. Thus, when executing these tests, the code may encounter various feature toggles. Typically, feature toggles have a unique Application Programming Interface (“API”) to read out the toggle state. During test execution, the software stack has access to this information indicating which feature toggles were executed or touched and in which state. This information can be tracked and made transparent to the consumer of the tests. For a developer using an IDE, this would allow for the display of toggle information along with other coverage data (e.g., statement, branch, and or procedure coverages). The developer can gain immediate insight (such as “this toggle is still consumed by the productive coding, even though it is already rolled out to all customers and should be removed”). Furthermore, the developer can gain insight into whether the code being worked on also depends on other feature toggles maintained by other developers (for example, there could a hidden dependency between feature toggles that leads to unwanted side effects). Additionally, the display of feature toggle coverage may also enable an easy access to the call stack of code that consumes the feature toggle. Beyond the use case of a developer working in an IDE, such tooling can also leverage the quality assurance of a CI/CD pipeline. Failing automatic tests within such pipelines helps prevent the integration of problematic code into the delivery. Missing test coverage can also be a reason for a pipeline failure. By measuring feature toggle coverage explicitly, additional code metrics may be determined for quality assurance. Depending on the status of the feature toggle (e.g., in rollout), one can define an expected status within tests and fail the pipeline when mandatory tests are missing.

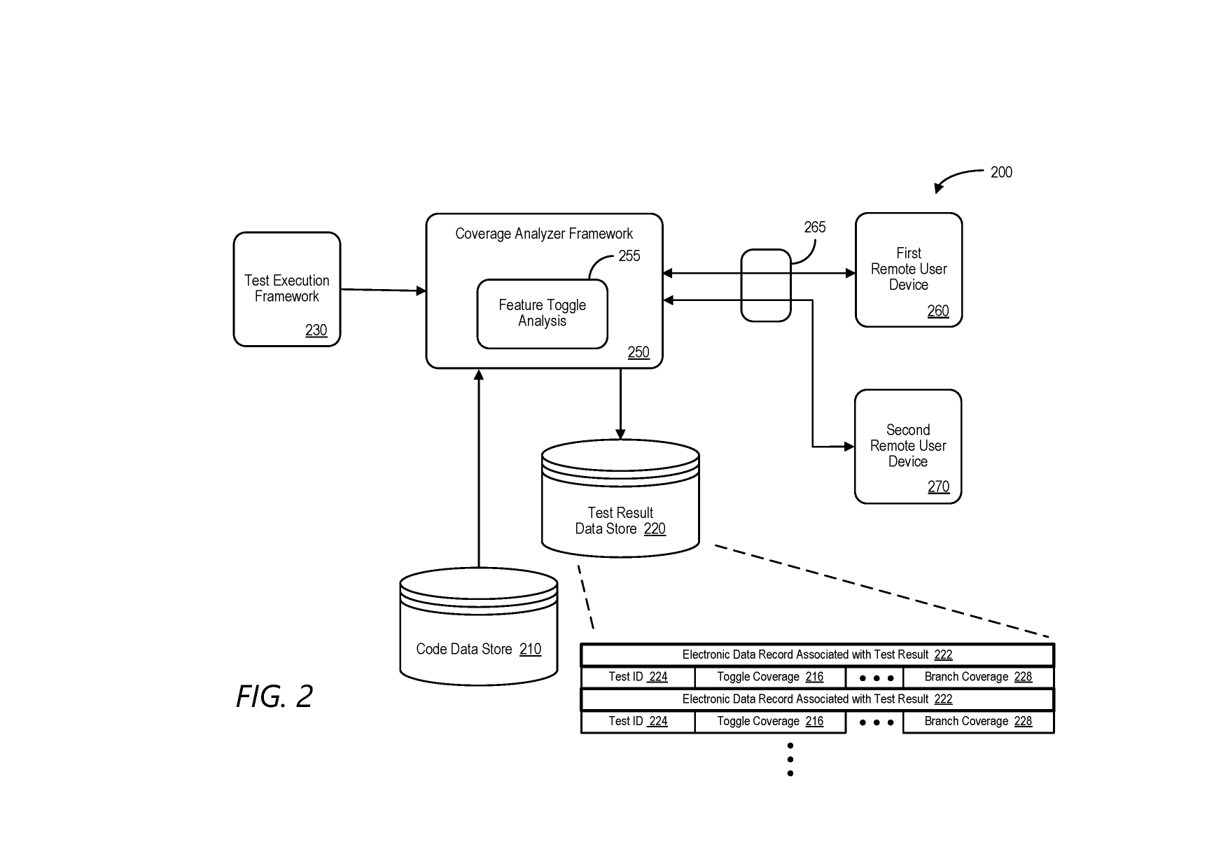

FIG. 2 is a high-level software test system architecture in accordance with some embodiments. In particular, the system 200 includes a coverage analyzer framework 250 that may access information in a code data store 210 that contains software being developed. The coverage analyzer framework 250 may also store information into other data stores, such as a test result data store 220 containing information about a test initiated by a test execution framework 230 (e.g., a set of electronic records associated with test results 222, each record including, for example, one or more test identifiers 224, toggle coverage values 226, branch coverage values 228, etc.), and utilize a feature toggle analysis 255 to view, analyze, and/or update electronic records. The coverage analyzer framework 250 may also exchange information with a first remote user device 260 and a second remote user device 270 (e.g., via a firewall 265). According to some embodiments, an interactive Graphical User Interface (“GUI”) platform of the coverage analyzer framework 250 may facilitate the creation and review of testing analysis, recommendations, alerts, and/or the display of results via one or more remote administrator computers (e.g., to summarize system 200 performance) and/or the remote user devices 260, 270. For example, the first remote user device 260 may transmit annotated and/or updated information to the coverage analyzer framework 250. Based on the updated information, the coverage analyzer framework 250 may adjust data in the test result data store 220 and the change may (or may not) be used in connection with the second remote user device 270. Note that the coverage analyzer framework 250 and/or any of the other devices and methods described herein might be associated with a third party, such as a vendor that performs a service for an enterprise.

The coverage analyzer framework 250 and/or the other elements of the system 200 might be, for example, associated with a Personal Computer (“PC”), laptop computer, smartphone, an enterprise server, a server farm, and/or a database or similar storage devices. According to some embodiments, an “automated” coverage analyzer framework 250 (and/or other elements of the system 200) may facilitate the automated access and/or update of electronic records in the data stores 210, 220 and/or the management or reporting of automated tests. As used herein, the term “automated” may refer to, for example, actions that can be performed with little (or no) intervention by a human.

Devices, including those associated with the coverage analyzer framework 250 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The coverage analyzer framework 250 may store information into and/or retrieve information from the code data store 210 and/or the test result data store 220, which may be locally stored or reside remote from the coverage analyzer framework 250. As will be described further, the code data store 210 may be used by the coverage analyzer framework 250 in connection with an interactive user interface to access and update electronic records. Although a single coverage analyzer framework 250 is shown in FIG. 2, any number of such devices may be included. Moreover, various devices described herein might be combined according to embodiments of the present invention. For example, in some embodiments, the coverage analyzer framework 250 and code data store 210 might be co-located and/or may comprise a single apparatus.

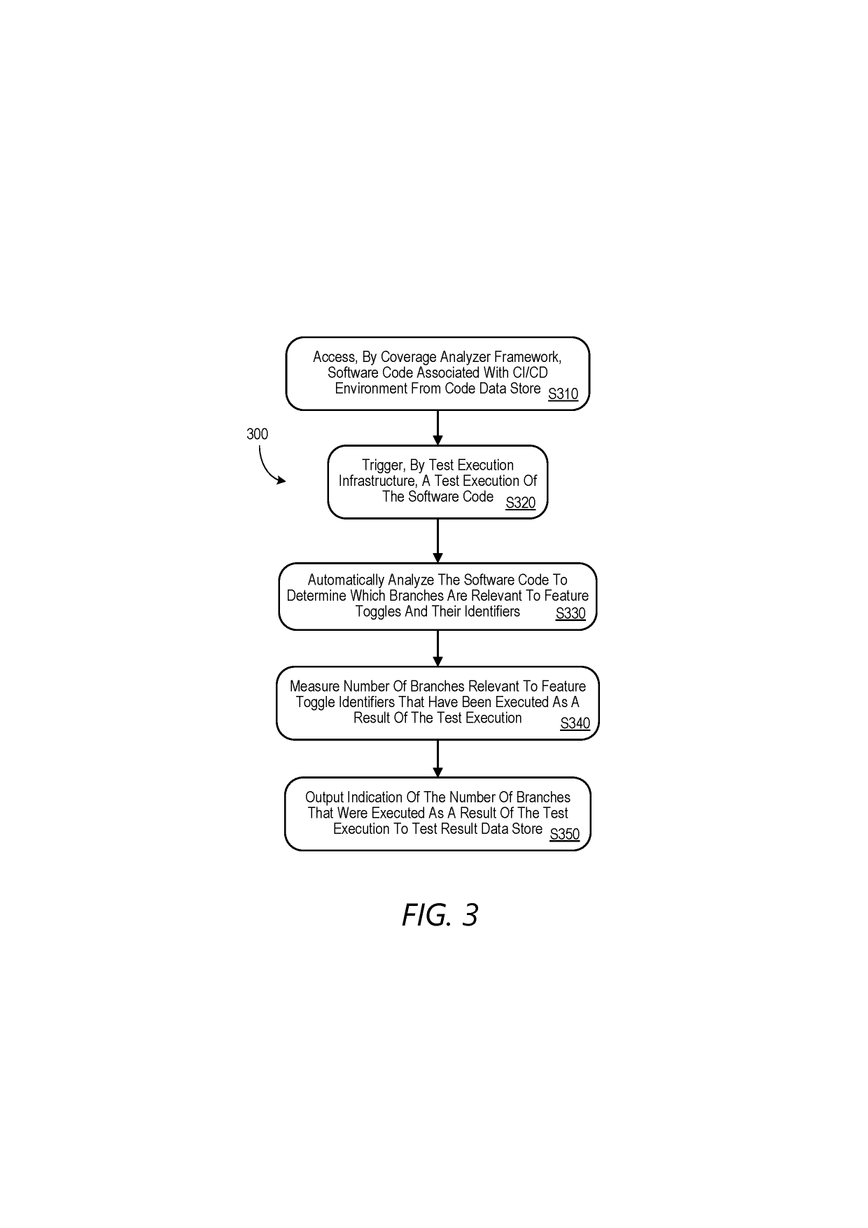

The elements of the system 200 may work together to perform the various embodiments of the present invention. Note that the system 200 of FIG. 2 is provided only as an example, and embodiments may be associated with additional or fewer elements or components. According to some embodiments, the elements of the system 200 automatically transmit information associated with an interactive user interface display over a distributed communication network. FIG. 3 is a software test method 300 that might be performed, for example, by the system 200 of FIG. 2 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a computer processor of a coverage analyzer framework may access software code associated with a CI/CD environment from a code data store. A test execution infrastructure can then trigger a test execution of software code at S320. The test execution infrastructure might be associated with, for example, a developer using an Integrated Development Environment (“IDE”) or a CI/CD pipeline quality assurance. Moreover, the test execution might be associated with a unit test, a component test, an integration test, a provider test, a User Interface (“UI”) test, an end-to-end test, etc.

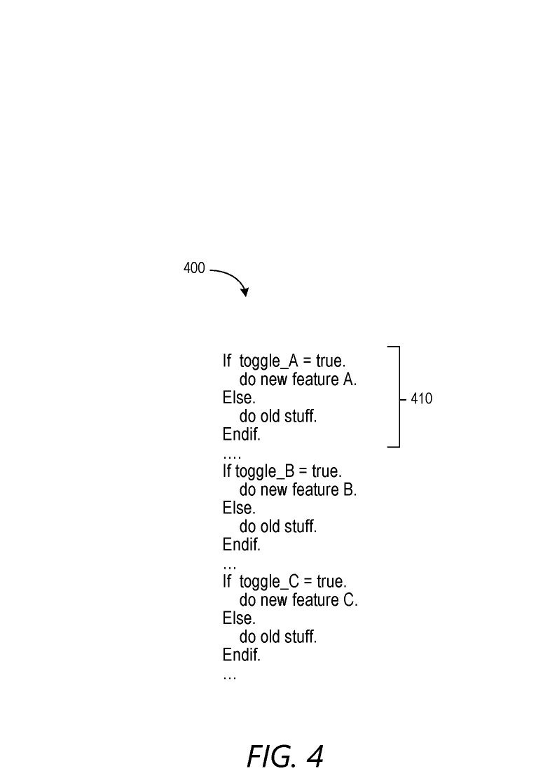

At S330, the coverage analyzer framework determines which branches within the software code are relevant to feature toggles and their identifiers. The measurement of the number of branches relevant to feature toggles might be associated with, for example, an automated code analysis, or an automated trace analysis. For example, FIG. 4 is software code 400 with feature toggles 410 associated with new features A through C in accordance with some embodiments. In this case, the analyzer might search for particular if-then-else patterns of the feature toggles 410. Referring again to FIG. 3, at S340 a number of branches relevant to feature toggle identifiers that have been executed as a result of the test execution is determined. According to some embodiments, the coverage analyzer framework is further to read toggle execution status via a feature toggle Application Programming Interface (“API”).

The system may then output an indication of the number of branches relevant to feature toggles that were executed as a result of the test execution at S350. For example, the indication may be output as a toggle metric to a test result data store. In some embodiments, the test result data store further contains an overall branch coverage metric, a statement coverage metric, and/or a procedure coverage metric. Moreover, production deployment of the software code may be automatically blocked if the toggle metric falls below a required value for the given toggle. In addition, the coverage analyzer framework might further flag portions of the software code for potential removal (e.g., reachable code).

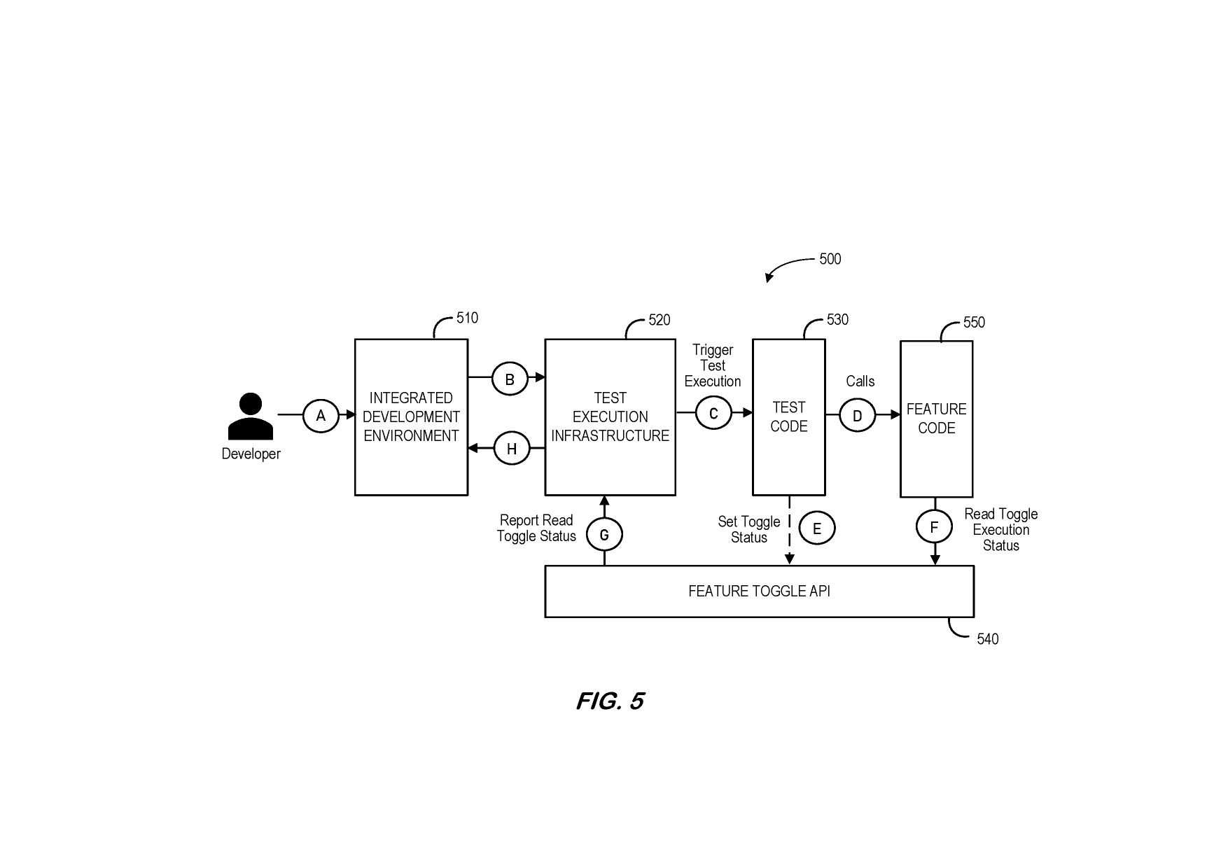

FIG. 5 is an Integrated Development Environment (“IDE”) coverage analysis 500 according to some embodiments. A developer may utilize an IDE at (A) to access a test execution infrastructure 520 at (B). In this way, a test execution may be triggered at (C), resulting in execution of test code 530. In some embodiments, the execution test code 530 may optionally set a toggle status via a feature toggle API 540 at (E) – depending on the type of test being executed. The execution test code 530 also calls feature code 550 at (D). The feature code 550 then reads the toggle status at (F), and the read toggle execution status is reported to the test execution infrastructure 520 at (G). At (H), the test execution infrastructure 520 sends the test results to the IDE 510.

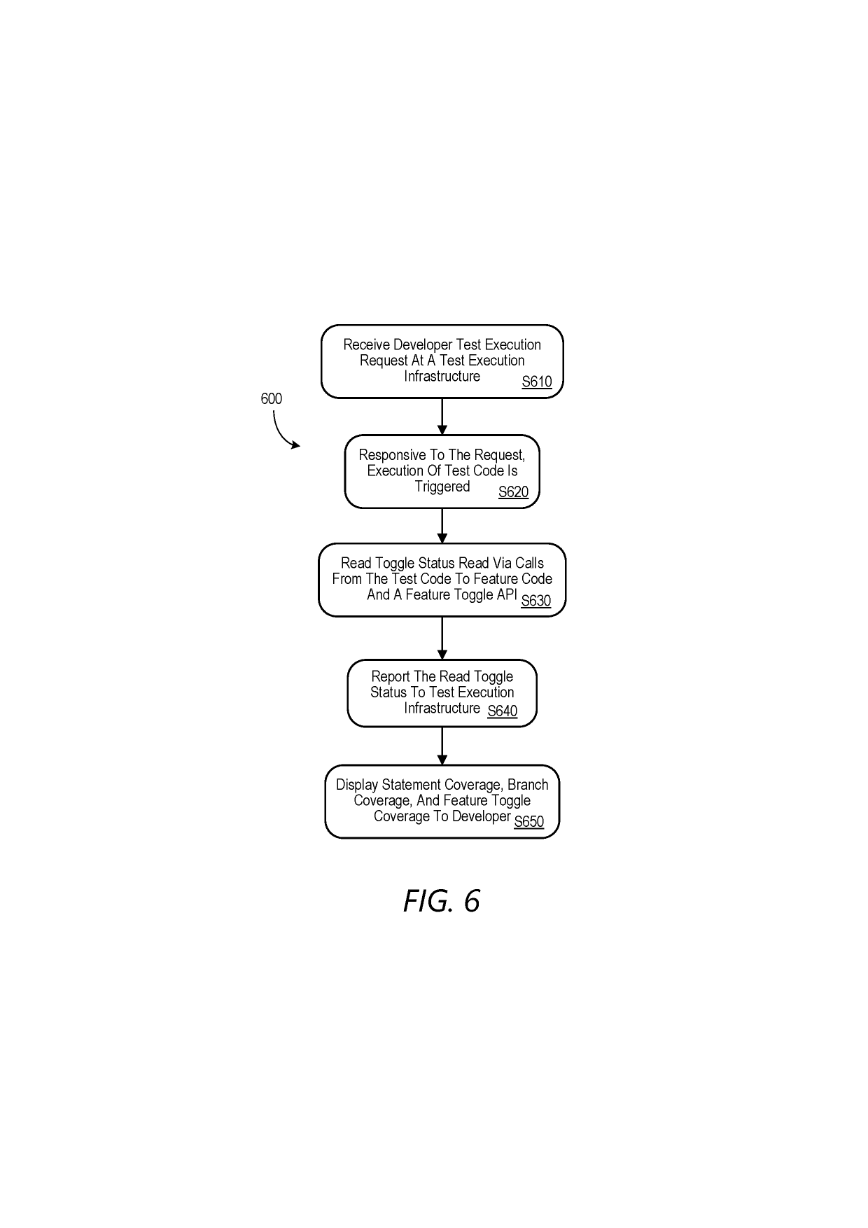

FIG. 6 is an IDE method 600 in accordance with some embodiments. At S610, a test execution infrastructure receives a test execution request from a developer. Responsive to the request, at S620 execution of test code is triggered. At S630, toggle status is read via calls to feature code and a feature toggle API. At S640, the read toggle execution status is reported to the test execution infrastructure. The feature toggle coverage can then be displayed to the developer at S650 along with statement coverage, branch coverage, etc.

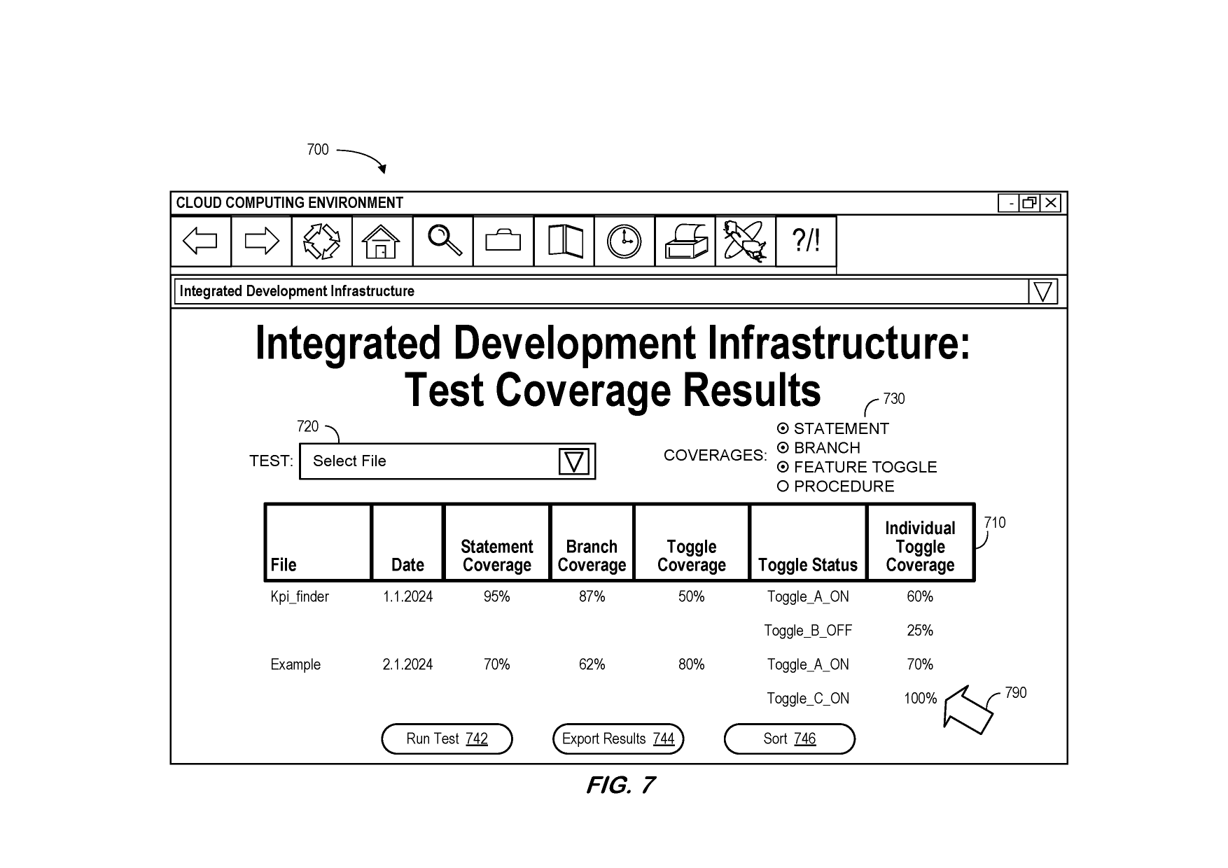

FIG. 7 is an IDE test results display 700 according to some embodiments. The display 700 includes a test results table 710 including, for various files, coverage metrics such as a test date, a statement coverage value, a branch coverage value, a toggle coverage value, a toggle status, individual toggle coverage, etc. Selection of an element in the test results table 710 (e.g., via a computer mouse pointer 790) may result in the display of additional information, such as the total number toggles that were found in the code. The display 700 may also be used by a developer to select a file 720 (containing the code to be tested), select coverages of interest 730, select a “Run Test” icon 742 to initiate a test, select an “Export Results” icon 744 to save the test results, select a “Sort” icon 746 to re-arrange the table 710, etc. Note that embodiments may provide an ability to drill down to the coverage on individual toggle level. A “Toggle_A” might be used three times in three branches in a method and thus can have 66% toggle coverage only. But a developer may want to release this toggle sooner than other toggles in the same method and be most interested in the coverage for “Toggle_A.” Thus, the overall toggle coverage for an object may be insufficient and embodiments may provide an ability to see it on a per toggle basis.

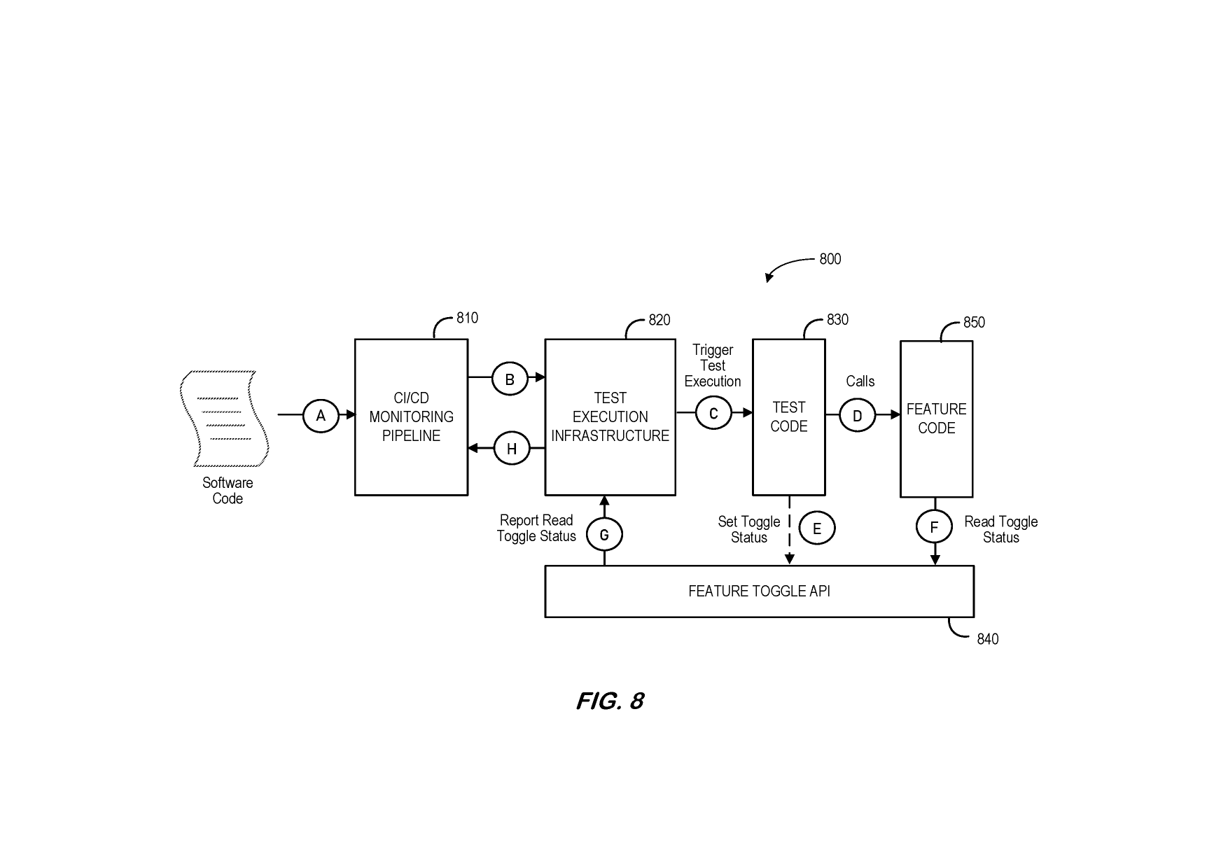

In addition to an IDE implementation, some embodiments may be associated with a CI/CD pipeline. For example, FIG. 8 is a CI/CD monitoring pipeline analysis 800 in accordance with some embodiments. Software code being developed is accessed by a CI/CD monitoring pipeline at (A) and sent to a test execution infrastructure 820 at (B). In this way, a test execution may be triggered at (C), resulting in execution of test code 830. In some embodiments, the execution test code 830 may optionally set a toggle status via a feature toggle API 840 at (E) – depending on the type of test being executed. The execution test code 830 also calls feature code 850 at (D). The feature code 850 then reads the toggle status at (F), and the read toggle execution status is reported to the test execution infrastructure 820 at (G). At (H), the test execution infrastructure 820 sends the test results to the CI/CD monitoring platform 810 (which could potentially block deployment of the software code depending on the test results).

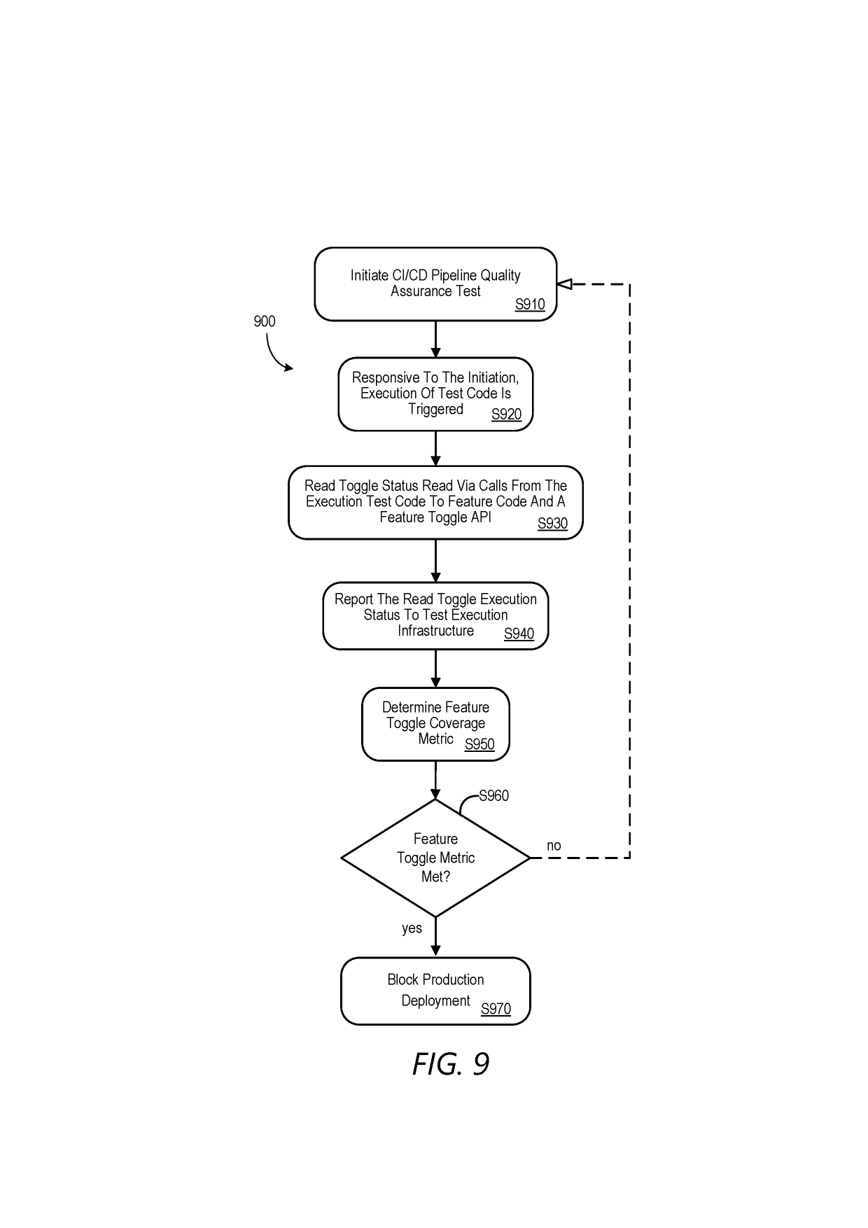

FIG. 9 is an IDE method 900 in accordance with some embodiments. At S910, a CI/CD pipeline quality assurance test is initiated. Responsive to the initiation, at S920 execution of test code is triggered. At S930, toggle status is read via calls to feature code and a feature toggle API. At S940, the read execution toggle status is reported to the test execution infrastructure. A feature toggle coverage metric is determined at S950. If the feature toggle coverage metric is not met at S960, the coverage is adequate (and no further action needs to be taken in view of that result). If the feature toggle coverage metric is met at S960, deployment of the software code mat be prevented at S970 until proper testing is completed.

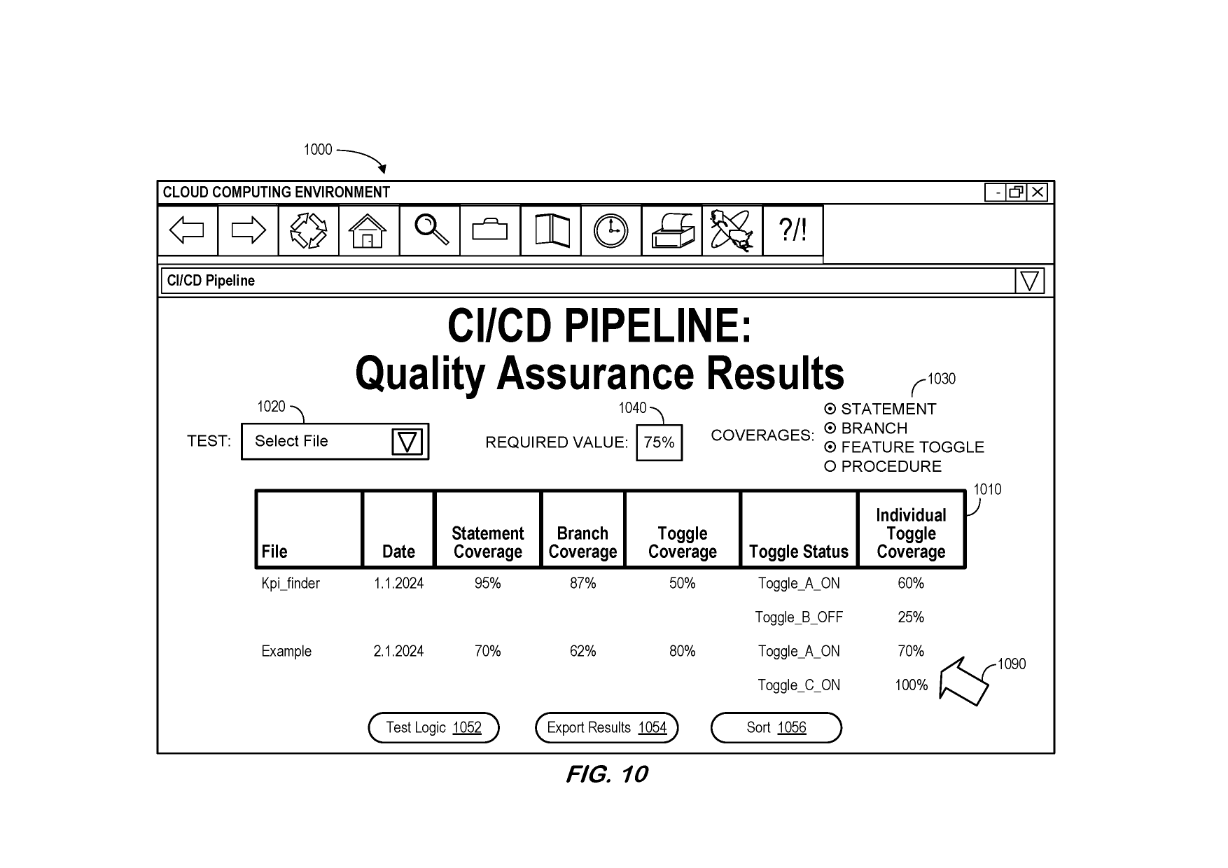

FIG. 10 is a CI/CD pipeline test results display 1000 according to some embodiments. The display 1000 includes a test results table 1010 including, for various files, coverage metrics such as a test date, a statement coverage value, a branch coverage value, a toggle coverage value, a toggle status, individual toggle coverage, etc. Selection of an element in the test results table 1010 (e.g., via a computer mouse pointer 1090) may result in the display of additional information. The display 1000 may also be used by a developer to select a file 1020 (containing the code to be tested), select coverages of interest 1030, select a toggle threshold 1040 indicating an acceptable level of test coverage, select a “Test Logic” icon 1052 to configure test rules or logic, select an “Export Results” icon 1054 to save the test results, select a “Sort” icon 1056 to re-arrange the table 1010, etc.

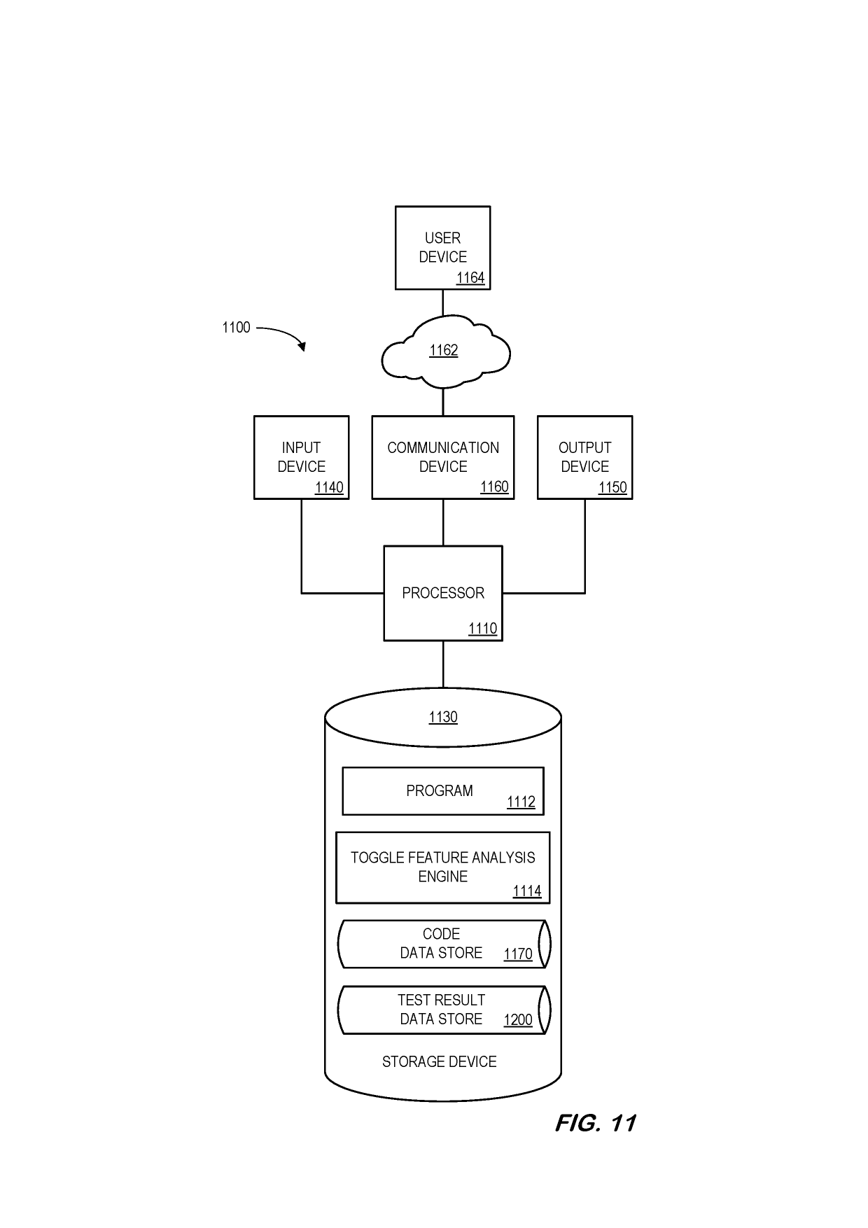

Note that the embodiments described herein may be implemented using any number of different hardware configurations. For example, FIG. 11 is a block diagram of an apparatus or platform 1100 that may be, for example, associated with the system 200 of FIG. 2 (and/or any other system described herein). The platform 1100 comprises a processor 1110, such as one or more commercially available Central Processing Units (“CPUs”) in the form of one-chip microprocessors, coupled to a communication device 1160 configured to communicate via a communication network 1162. The communication device 1160 may be used to communicate, for example, with one or more remote user devices 1164, monitoring pipelines, administrator platforms, etc. The platform 1100 further includes an input device 1140 (e.g., a computer mouse and/or keyboard to input data mappings and/or toggle pattern rules) and/or an output device 1150 (e.g., a computer monitor to render a display, transmit recommendations and alerts, and/or create reports about test results, feedback to improve system performance, etc.).

The processor 1110 also communicates with a storage device 1130. The storage device 1130 may comprise any appropriate information storage device, including combinations of magnetic storage devices (e.g., a hard disk drive), optical storage devices, mobile telephones, and/or semiconductor memory devices. The storage device 1130 stores a program 1112 and/or toggle feature analysis engine 1114 for controlling the processor 1110. The processor 1110 performs instructions of the programs 1112, 1114, and thereby operates in accordance with any of the embodiments described herein. For example, the processor 1110 may trigger a test execution of the software code causing an automatic analysis of the software code and a determination of which branches within the software code are relevant to feature toggles and their identifiers. The processor 1110 can then measure a number of branches relevant to feature toggles that have been executed as a result of the test execution. An indication of the number of branches relevant to feature toggles that were executed as a result of the test execution may be stored by the processor 1110 as a toggle metric into a test result data store 1200. According to some embodiments, the test result data store further contains an overall branch coverage metric, a statement coverage metric, a procedure coverage metric, etc.

The programs 1112, 1114 may be stored in a compressed, uncompiled and/or encrypted format. The programs 1112, 1114 may furthermore include other program elements, such as an operating system, clipboard application, a database management system, and/or device drivers used by the processor 1110 to interface with peripheral devices.

As used herein, information may be “received” by or “transmitted” to, for example: (i) the platform 1100 from another device; or (ii) a software application or module within the platform 1100 from another software application, module, or any other source.

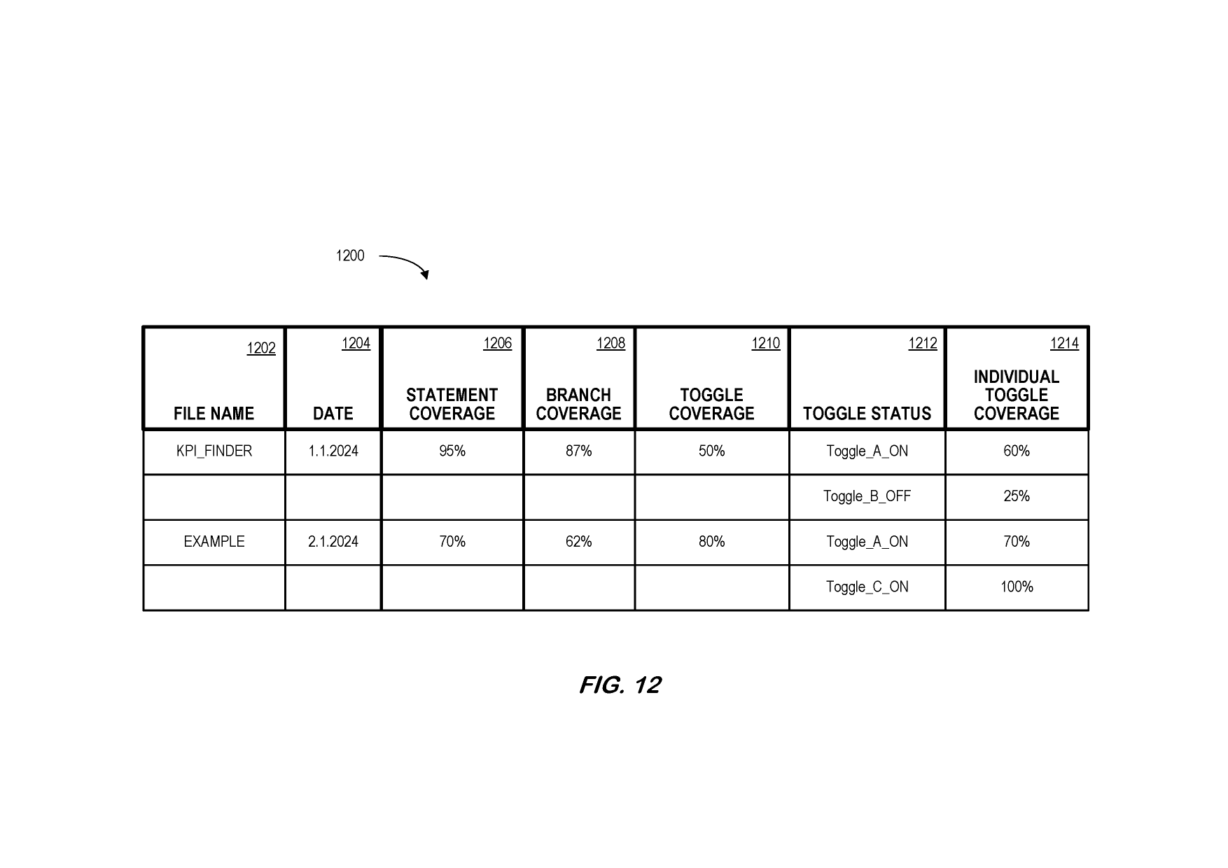

In some embodiments (such as the one shown in FIG. 11), the storage device 1130 further stores a code data store 1170 and the test result data store 1200. An example of a database that may be used in connection with the platform 1100 will now be described in detail with respect to FIG. 12. Note that the database described herein is only one example, and additional and/or different information may be stored therein. Moreover, various databases might be split or combined in accordance with any of the embodiments described herein.

Referring to FIG. 12, a table is shown that represents the test result store 1200 that may be stored at the platform 1100 according to some embodiments. The table may include, for example, entries identifying ticket information associated with enterprise application incidents. The table may also define fields 1202, 1204, 1206, 1208, 1210 for each of the entries. The fields 1202, 1204, 1206, 1208, 1210 may, according to some embodiments, specify: a file name 1202, a date 1204, statement coverage 1206, branch coverage 1208, toggle coverage 1210, toggle status 1212, and individual toggle coverage 1214. The test result data store 1200 may be created and updated, for example, when a new is triggered by a developer, results are updated by the system, etc.

The file name 1202 might be a unique alphanumeric label that is associated with execution of a particular automated test for the software code of that file. The date 1204 may indicate when the test was performed. The statemeent coverage 1206 indicates a percentage of statements that were executed during the test. The branch coverage 1208 indicates a percentage of branches that were executed during the test. The toggle coverage 1210 is associated with toggles that were covered during the test. The toggle status 1212 may indicate if a feature toggle identifier is “on” or “off,” the individual toggle coverage 1214 indicates a percentage of coverage for the specific toggle identifier, etc.

In this way, embodiments may provide coverage analysis of software code branches that are associated with feature toggles in a secure, automatic, and efficient manner. Although existing metrics (such as branch coverage) could potentially reveal missing test cases, this may require 100% branch coverage (which is extremely difficult to achieve). Moreover, such an approach might force developers to test branches that are of low interest with respect to functional correctness. Thus, safeguarding the feature toggle lifecycle may not be feasible using branch coverage.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

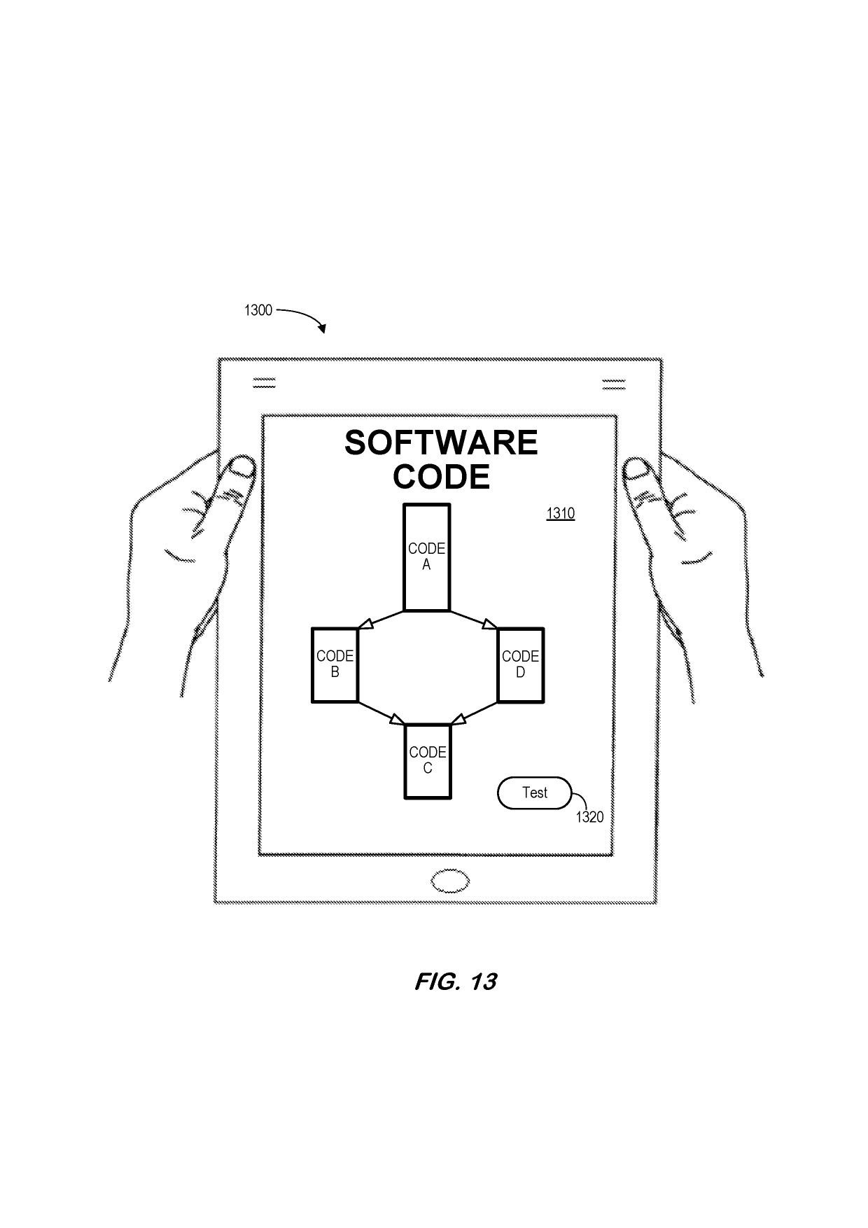

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of business applications, any of the embodiments described herein could be applied to other types of business applications. Moreover, the displays shown herein are provided only as examples, and any other type of user interface could be implemented. For example, FIG. 13 illustrates a tablet computer 1300 providing software code display 1310 including code, branches, toggles, etc. The display 1310 might be used, for example, to investigate aspects of an application problem using a “Test” icon 1320.

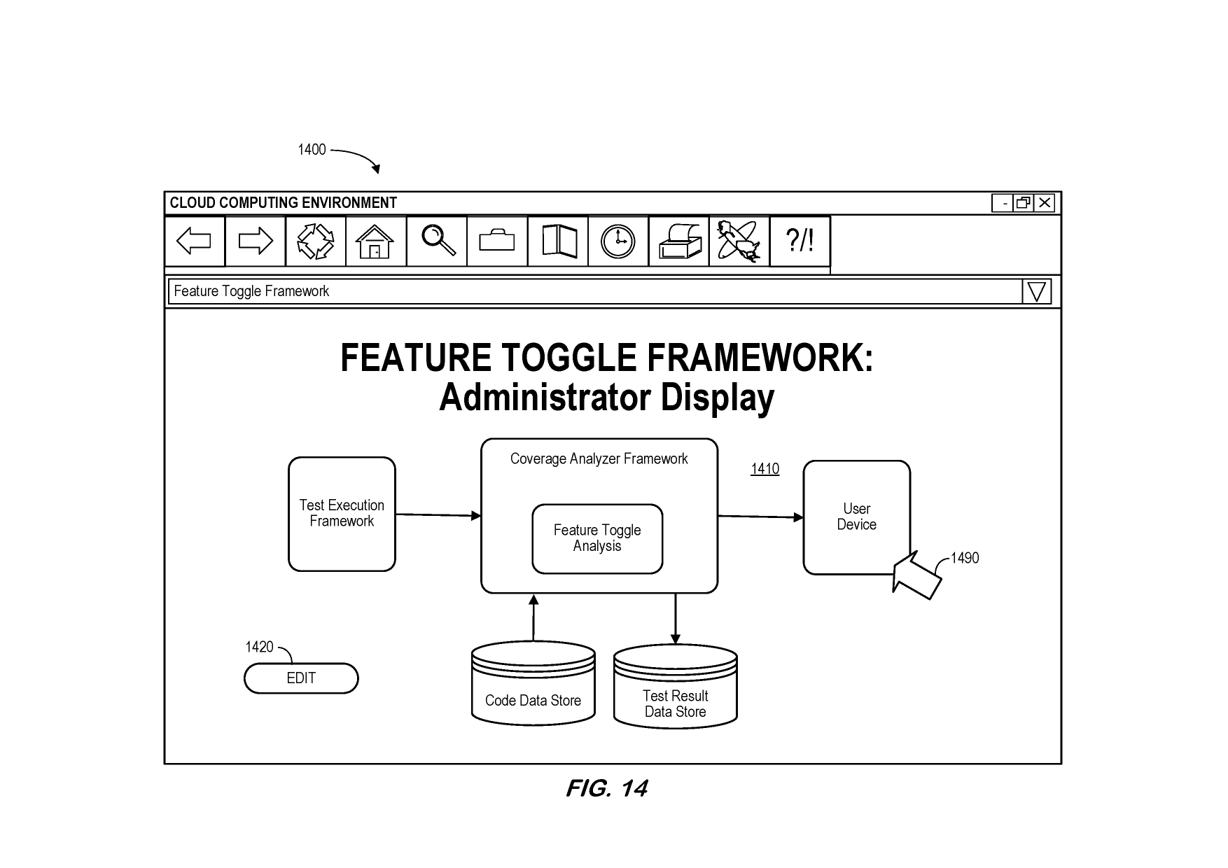

FIG. 14 is an operator or administrator display in accordance with some embodiments. The display 1400 includes a graphical representation 1410 of a coverage analyzer framework in accordance with any of the embodiments described herein. Selection of an element on the display 1400 (e.g., via a touchscreen or computer pointer 1490) may result in display of a pop-up window containing more detailed information about that element and/or various options (e.g., customized threshold details, mappings to database, result report summaries, etc.). Selection of an “Edit” icon 1420 may also let an operator or administrator adjust the operation of the system (e.g., to change system mappings, adjust toggled pattern rules or logic, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system for a Continuous Integration and Continuous Deployment (“CI/CD”) environment, comprising:
a code data store containing software code associated with the CI/CD environment;
test execution infrastructure able to trigger a test execution of the software code;
a coverage analyzer framework, coupled to the code data store and test execution framework, including:
a computer processor, and
a computer memory storing instructions that, when executed by the computer processor, cause the coverage analyzer framework to perform the following steps:
automatically analyze the software code to determine which branches within the software code are relevant to feature toggles and their identifiers,
measure a number of branches relevant to feature toggle identifiers that have been executed as a result of the test execution, and
output an indication of the number of branches relevant to feature toggles that were executed as a result of the test execution; and
a test result data store containing a toggle metric associated with the number of branches relevant to feature toggles that were executed as a result of the test execution.

2. The system of claim 1, wherein the coverage analyzer framework is further to read toggle execution status via a feature toggle Application Programming Interface (“API”).

3. The system of claim 1, wherein the test result data store further contains at least one of: (i) an overall branch coverage metric, (ii) a statement coverage metric, and (iii) a procedure coverage metric.

4. The system of claim 1, wherein the test execution infrastructure is associated with a developer using an Integrated Development Environment (“IDE”).

5. The system of claim 1, wherein the test execution infrastructure is associated with a CI/CD pipeline quality assurance.

6. The system of claim 5, wherein production deployment of the software code is automatically blocked if the toggle metric falls below a required value.

7. The system of claim 1, wherein the test result data store further contains information about feature toggle dependencies.

8. The system of claim 1, wherein the coverage analyzer framework is further to flag portions of the software code for potential removal.

9. The system of claim 1, wherein the test execution is associated with at least one of: (i) a unit test, (ii) a component test, (iii) an integration test, (iv) a provider test, (v) a User Interface (“UI”) test, and (vi) an end-to-end test.

10. The system of claim 1, wherein measurement of the number of branches relevant to feature toggle identifiers is associated with at least one of: (i) an automated code analysis, and (ii) an automated trace analysis.

11. A computer-implemented method for a Continuous Integration and Continuous Deployment (“CI/CD”) environment, comprising:
accessing, by a computer processor of a coverage analyzer framework, software code associated with the CI/CD environment from a code data store;
triggering, by a test execution infrastructure, a test execution of the software code;
automatically analyzing the software code to determine which branches within the software code are relevant to feature toggles and their identifiers;
measuring a number of branches relevant to feature toggle identifiers that have been executed as a result of the test execution;
based on the number of branches relevant to feature toggles that were executed as a result of the test execution to a test result data store, a toggle feature metric is determined; and
displaying toggle feature coverage metric, an overall branch coverage metric, and a statement coverage metric.

12. The method of claim 11, wherein the coverage analyzer framework is further to read toggle execution status via a feature toggle Application Programming Interface (“API”).

13. The method of claim 11, wherein the test execution infrastructure is associated with a developer using an Integrated Development Environment (“IDE”).

14. The method of claim 11, wherein the test execution infrastructure is associated with a CI/CD pipeline quality assurance.

15. The method of claim 14, wherein production deployment of the software code is automatically blocked if the toggle metric falls below a required value.

16. One or more non-transitory computer-readable media storing computer-executable instructions that, when executed by a computing system, cause the computing system to perform operations for a Continuous Integration and Continuous Deployment (“CI/CD”) environment comprising:
accessing, by a computer processor of a coverage analyzer framework, software code associated with the CI/CD environment from a code data store;
triggering, by a test execution infrastructure, a test execution of the software code;
automatically analyzing the software code to determine which branches within the software code are relevant to feature toggles and their identifiers;
measuring a number of branches relevant to feature toggle identifiers that have been executed as a result of the test execution; and
outputting an indication of the number of branches relevant to feature toggles that were executed as a result of the test execution as a toggle metric to a test result data store.

17. The media of claim 16, wherein the test result data store further contains information about feature toggle dependencies.

18. The media of claim 16, wherein the coverage analyzer framework is further to flag portions of the software code for potential removal.

19. The media of claim 16, wherein the test execution is associated with at least one of: (i) a unit test, (ii) a component test, (iii) an integration test, (iv) a provider test, (v) a User Interface (“UI”) test, and (vi) an end-to-end test.

20. The media of claim 16, wherein measurement of the number of branches relevant to feature toggle identifiers is associated with at least one of: (i) an automated code analysis, and (ii) an automated trace analysis.
